(19) United States
(12) Patent Application Publication
(10) Pub. No.: US 2009/0104316 A1
(43) Pub. Date: Apr. 23, 2009

(54) FROZEN PRODUCT

(75) Inventors: Sarah MARKILLIE, Auckland (NZ); Murray TAYLOR, Auckland (NZ); Julia CROWNSHAW, Mt Maunganui (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA BRANDS GROUP LIMITED, Auckland (NZ)

(21) Appl. No.: 11/720,424

(22) PCT Filed: Nov. 2, 2005
(86) PCT No.: PCT/NZ05/00291

§ 371 Date: Sep. 30, 2008

(30) Foreign Application Priority Data
Nov. 29, 2004 (NZ) 536902
Feb. 14, 2005 (NZ) 538269
May 11, 2005 (NZ) 539965

(51) Int. Cl. A23L 2/00; B65D 81/34

(52) U.S. Cl. 426/107; 426/241

(57) ABSTRACT

A microwavable product capable from a frozen state of its gas and ice including composition, whilst still in all or part of its container in which it has been frozen or been held frozen, of being microwave heated to a foamy hot beverage, the composition having a stabiliser and at least one type of dairy inclusion.

The present invention relates to a frozen product and more particularly although not solely to a microwaveable product capable, from a frozen state, of being microwave heated to a foamy hot beverage, a beverage product capable in its container and/or another container of being microwave heated from a frozen composition state to a hot beverage form, a frozen packaged product useful as a product as aforesaid, and related methods, procedures and product forms.

The present invention sees an advantage insofar as product interest is concerned in a frozen beverage product capable, simply by microwave heating (preferably without any removal from the container in which it has been supplied), to allow a palatable interesting foamy hot product.

The present invention also recognises an ability to create with air overrun (or other gas overrun) a substantially homogeneous composition, with appropriate flavourings of any kind (most preferably of a chocolate or coffee kind but not necessarily so) which, because of the nature of the preferred gas entrapment in the frozen product, for example in conjunction with proteins, dairy products and/or other contents, provides a product that is palatable, thick and/or foamy and retains these characteristics perhaps as long as 1 hour and certainly for the period it remains hot.

The present invention also envisages an advantage to be derived from a form of packed microwaveable product where, by removal of any tamper evident feature, a lid, or the like, the still substantially frozen product with some measure of venting can be microwave heated thereafter to be imbibed. Such a product is ideally a thick foamy hot beverage upon heating to desired temperature range of from, for example, 40° C. to 60° C., for consumption at temperatures of 35° C. to 60° C. or below.

It is therefore to one or more of the aforementioned aims or objects of the present invention and related methodologies is directed.

In one aspect the invention is a microwavable product capable from a frozen state (preferably of a part dairy product) whilst still in all or part of its container in which it has been frozen, of being safely microwave heated to a foamy hot beverage.

In another aspect the invention is a microwavable product capable from a frozen state of its gas and ice including composition, whilst still in all or part of its container in which it has been frozen, of being safely microwave heated to a foamy hot beverage.

In still another aspect the invention is a microwavable product being a frozen composition in an openable container, the product being capable from a frozen state of its composition, whilst still in all or part of its container (preferably in which it has been frozen), of being microwave heated to a foamy hot beverage capable of being drunk from the container or part container.

In yet another aspect the invention is a microwavable product capable from a frozen state of its gas and ice including composition, whilst still in all or part of its container in which it has been frozen, of being microwave heated to a foamy hot beverage, the frozen composition having spread there throughout at least one or more of:

(i) ice crystals of from 5 to 120 μm, but preferably from 5 to 30 μm,

(ii) fat globules of from 0.2 to 40 μm, and

(iii) air cells of from 5 to 185 μm, but preferably from 60 μm

Preferably the composition has a stabiliser (e.g. Pectin), and at least one type of dairy inclusion.

Preferably protein is present (optionally as one dairy inclusion).

Preferably at least one source of carbohydrate is present.

Preferably the composition prior to freezing is an air (or other gas) overrun mix of at least

(i) a milk concentrate,

(ii) a milk protein extract or powder,

(iii) cream, and

(iv) at least one carbohydrate.

Preferably a stabiliser is present (e.g. Pectin, Sodium Alginate, or the like).

Preferably the overrun is of from 10% to 120%, but preferably from 20% to 40%.

Preferably there is present at least 0.5% ^{w}/_{w} colloidal proteins, 5% ^{w}/_{w} carbohydrates and/or 0.01% ^{w}/_{w} stabiliser(s).

Preferably the composition prior to freezing has been a substantially homogenous mix of a gas(es) overrun [e.g. air overrun] composition of at least:

0 to 30% ^{w}/_{w} colloidal protein(s) [e.g. selected from dairy base, vegetable based proteins, and/or a mix],

0 to 20% ^{w}/_{w} fat(s) [e.g. selected from dairy and/or vegetable based fats],

0 to 40% ^{w}/_{w} carbohydrate(s) [e.g. selected from sucrose, glucose, fructose, glycerin and/or any other carbohydrate used to supply solids and sweetness],

0 to 5% ^{w}/_{w} stabilising agent(s) [e.g. selected from Pectin, CMC, Locust Bean Gum, Guar Gum, Sodium Alginate, Carrageenan, and/or Xanthan],

0 to 10% ^{w}/_{w} flavouring(s) [e.g. selected from coffee, cocoa, chocolate, caramel, nut and/or any other flavouring substance],

0 to 90% ^{w}/_{w} water.

Preferably there is at least 0.5% ^{w}/_{w} colloidal protein(s).

Preferably there is at least 5% ^{w}/_{w} carbohydrate(s).

Preferably there is at least 0.01% ^{w}/_{w} stabilising agent(s).

In another aspect the invention is a microwavable product capable from a frozen state of its (preferably gas and ice including) composition, whilst still in all or part of its container in which it has been frozen, of being microwave heated to a foamy hot beverage, the composition having a stabiliser (e.g. sodium alginate), and at least one type of dairy inclusion.

Preferably protein is present (optionally as one dairy inclusion).

Preferably at least one source of carbohydrate is present.

In still another aspect the invention is a microwavable product capable from a frozen state of its composition (preferably whilst still in all or part of its container in which it has been frozen), of being microwave heated to a foamy hot beverage, the composition prior to freezing being an air overrun mix of at least:

(i) a milk concentrate,

(ii) a milk protein extract (powder),

(iii) cream, and

(iv) carbohydrates.

Preferably a stabiliser is present (e.g. Pectin, Sodium Alginate, or the like).

Preferably the overrun is of from 10% to 120%, but preferably from 20% to 40%.

Preferably there is present at least 0.5% ^{w}/_{w} colloidal proteins, 5% ^{w}/_{w} carbohydrates and/or 0.01% ^{w}/_{w} stabiliser(s).

In another aspect the invention is a microwavable product capable from a frozen state of its gas and ice including composition [which in frozen state has ice crystals, fat(s), protein(s) and carbohydrate(s) (optionally also salts)], whilst still in all or part of its container in which it has been frozen, of being microwave heated to a foamy hot beverage.

In another aspect the invention is a microwavable product capable from a frozen state of its gas and ice including composition, whilst still in all or part of its at least mainly microwave safe sealed cardboard container in which it has been frozen, of being microwave heated to a foamy hot beverage.

In another aspect the invention is a beverage product capable in its container and/or another container of being microwave heated from a frozen composition state to a hot beverage form, said product comprising or including

a container, and

a frozen composition in the container,

wherein the composition prior to freezing having been a substantially homogenous mix of a gas(es) overrun [e.g. air overrun] of at least:

0 to 30% ^{w}/_{w} colloidal protein(s) [e.g. selected from dairy base, vegetable based proteins, and/or a mix],

0 to 20% ^{w}/_{w} fat(s) [e.g. selected from dairy and/or vegetable based fats],

0 to 40% ^{w}/_{w} carbohydrate(s) [e.g. selected from sucrose, glucose, fructose, glycerin and/or any other carbohydrate used to supply solids and sweetness],

0 to 5% ^{w}/_{w} stabilising agent(s) [e.g. selected from Pectin, CMC, Locust Bean Gum, Guar Gum, Sodium Alginate, Carrageenan, and/or Xanthan],

0 to 10% ^{w}/_{w} flavouring(s) [e.g. selected from coffee, cocoa, chocolate, caramel, nut and/or any other flavouring substance],

0 to 90% ^{w}/_{w} water.

Preferably there is at least 0.5% ^{w}/_{w} colloidal protein(s).

Preferably there is at least 5% ^{w}/_{w} carbohydrate(s).

Preferably there is at least 0.01% ^{w}/_{w} stabilising agent(s).

Optionally, where coffee is a flavour, preferably a citrate (e.g. sodium citrate) is present.

Preferably the outcome is a product of any one or more of the foregoing kinds.

In a further aspect the present invention consists in a method of preparing the composition of a product of any one of the aforementioned kinds which method involves the preparation with churning, in order to ensure an overrun, a stable system for freezing which includes suspended fat globules, colloidal milk proteins, carbohydrates and salts (optionally with a stabilising agent or agents) and optionally with one or more flavour or flavouring agents.

In yet a further aspect the present invention consists in a composition suitable for a product of any aspect of the present invention preferably but not necessarily so when formed by a method in accordance with the present invention.

In another aspect the invention is a beverage pack comprising or including

at least substantially closed self supporting container, and

a chilled or frozen composition (e.g. a frozen confection) with incorporated air (or other gas) in the container [e.g. as aforesaid],

wherein the pack can be microwaved to heat the composition to a foamy beverage form,

and wherein the pack can be opened or penetrated to allow the drinking of the foamy beverage,

and wherein the container includes a venting feature above the level of the composition in the container.

Such venting feature is preferably to allow venting of at least one gas from the container during microwave heating and/or maintain gas until a desired temperature and resultant pressure is reached before allowing gas to be vented and/or is preferably adapted not to allow any substantial egress of liquid and/or foam during microwave heating.

Preferably in some forms of the present invention the at least substantially closed self supporting container is a cup having a removable lid.

Irrespective of the form of any pack of the composition, preferably there are carried instructions on how the pack or composition is to be microwave heated.

As used herein the term “and/or” includes “and” or “or” or both.

As used herein the term “(s)” following a noun includes the plural and singular forms of that noun.

As used herein “beverage” covers any fluid e.g. drinkable at least when heated.

The present invention will now be described with reference to the accompanying drawings in which

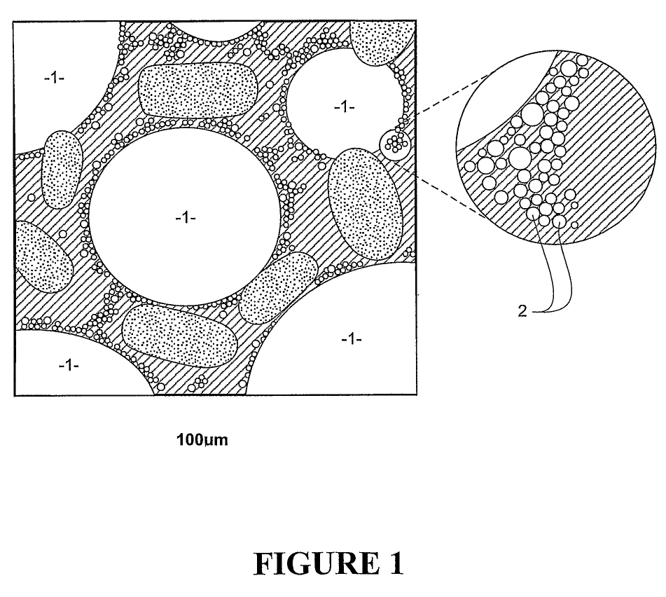

FIG. 1 is a diagram to demonstrate ice crystal and emulsified fat surrounded air cells,

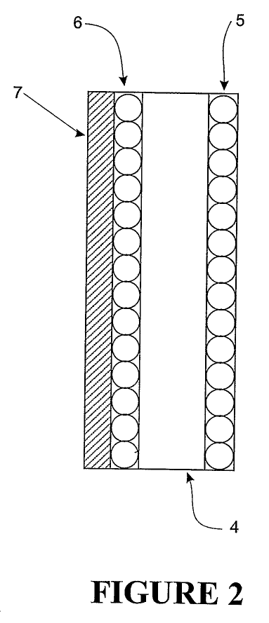

FIG. 2 is a cross section of a suitable microwave safe container wall,

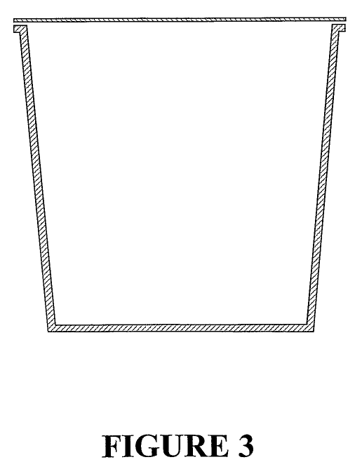

FIG. 3 shows the cross section of a vented lid/on cup pack for the composition and

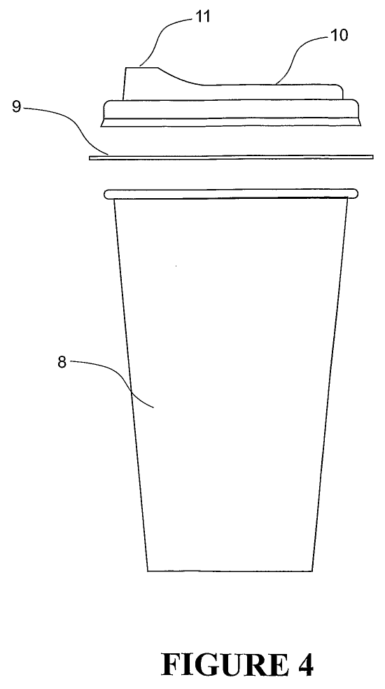

FIG. 4 shows a preferred pack as disclosed in our New Zealand Patent Application Nos. 539964 and that being filed simultaneously herewith.

The composition prior to freezing preferably has been a substantially homogenous mix of a gas(es) overrun [e.g. air overrun] composition of at least:

Up to 30% ^{w}/_{w} colloidal protein(s) [e.g. selected from dairy base, vegetable based proteins, and/or a mix] [preferably as a protein source and/or foam stabiliser],

Up to 20% ^{w}/_{w} fat(s) [e.g. selected from dairy and/or vegetable based fats],

Up to 40% ^{w}/_{w} carbohydrate(s) [e.g. selected from sucrose, glucose, fructose, glycerin, and/or any other carbohydrate used to supply solids and sweetness],

Up to 5% ^{w}/_{w} stabilising agent(s) [e.g. selected from Pectin, CMC, Locust Bean Gum, Guar Gum, Sodium Alginate, Carrageenan, and/or Xanthan],

Up to 10% ^{w}/_{w} flavouring(s) [e.g. selected from coffee, cocoa, chocolate, caramel, nut and/or any other flavouring substance],

Up to 90% ^{w}/_{w} water.

Optionally, where coffee is a flavour, preferably a citrate is present.

Preferably there is at least 0.5% ^{w}/_{w} colloidal protein(s).

Preferably there is at least 5% ^{w}/_{w} carbohydrate(s).

Preferably there is at least 0.01% ^{w}/_{w} stabilising agent(s).

### Product Overview and Consumer Benefit

The invention enables a product that is made as a frozen system to be stored by wholesalers, retailers, caterers, or end users and then, when energy is applied, results in a beverage which is designed to be drunk hot. Examples of such a product have been made in Hot Chocolate and Coffee formats, has a formulation that allows ideal drinking parameters when hot. The product is manufactured, distributed and stored in a frozen state and has an extended shelf life. The process used to manufacture this product allows the formation and stabilisation of small air cells in the system. On heating this results in a foamy layer in the product, which remains stable during consumption.

The consumer benefit from this product is a hot, thick, creamy, sweet and foamy drink, which is quick to prepare, and has an extended shelf life. It also has the benefit of real chocolate, coffee and fresh dairy ingredients which the powdered versions, which currently are the most popular form of take-home hot drinks, cannot always provide.

All percentages are on a ^{w}/_{w} basis unless otherwise stated or apparent.

### Preferred Formulation and Ingredients

The base formulation preferably used to make this product relies on the separate components to provide desirable parameters in the final product. Basically the mix prior to freezing is a liquid with suspended fat globules, colloidal proteins, carbohydrates and salts. Agitation that is received by the mix as it is churned (scraped surface) allows air to be incorporated into the mix (overrun), and the formation of ice crystals allows this air to become stable. The fat cells become crystalline, and to an extent coalesce which results in a structure, which supports the air cells in the mix. The ice crystals in this mix are around 5-120 μm, the fat globules 0.2-40 μm, and the air cells typically 5-60 μm. The product is designed to be frozen down to approx. −20° C., and at that temperature 85%-90% of the water in the system should be frozen. Each ingredient of this mix has a specific purpose.

FIG. 1 shows the air cells 1 surrounded by emulsified fat 2 and ice crystals 3.

### Cream and MSNF

Dairy ingredients preferably typically make up 14-15% of the formulation. The cream and milk concentrate [i.e. MSNF (milk solids not fat)] supply the dairy flavour and the creamy texture often associated with indulgent hot chocolates and coffees.

### Glucose

The level of sweetness used in this mix is lower than ice cream formulations as on heating the amount of sweetness the human palate can detect is increased, thus what tastes suitable when frozen is too sweet when heated up. The level used in this mix is designed to be ideal at hot temperatures.

Glucose preferably is used at approx. 19% (preferably as the only carbohydrate sweetener) and supplies solids without supplying too much sweetness, and also depresses the freezing point.

### Sucrose

Lower amounts of glucose can be used (e.g. approximately 5-6%) in conjunction with sucrose (e.g. at 6 to 20%) (e.g. 8-9%). Preferably sucrose is not used or is not used alone.

### Cocoa Powders

Cocoa powders (and chocolate ingredients) preferably are used in these products to get a rich chocolate flavour and aroma. In the Hot chocolate formulation several cocoa powders are preferably used and make up 1.5% of the formulation, in the Mochachino formulation preferably they supply 0.75% of the total mix, and in the coffee variant, preferably no cocoa powder is used.

### Chocolate

Real chocolate is preferably used in this formulation preferably at a level of approx. 2%. Its primary purpose is to give a rich, chocolate flavour and aroma, and to supply real chocolate content. Its presence may contribute to the fat and carbohydrate levels as well as flavourings.

### Coffee

Coffee is used in the coffee version of this product to supply a coffee flavour and aroma, supply coffee content and caffeine. It is preferably used at a level of between 0.75-2.0%.

### Protein Powder/Foam Stabiliser

Protein powder is preferably used at a level of between 0.5-2.0%. This allows the air to be incorporated more readily on churning of the mix, and stabilisation of the air cells once in the mix. This is done by the protein layering the interfacial layer between the aqueous phase and the air cell due to having both hydrophilic and hydrophobic portions, thus and causing stabilisation of the air cell. The protein also results in a thicker, creamier mouth feel when the mix is heated.

By way of example, a caseinate [e.g. sodium caseinate] can be used as the foam stabiliser up to 2% ^{w}/_{w}, more preferably up to 0.5% ^{w}/_{w} [e.g. most preferably about 0.1% ^{w}/_{w} sodium caseinate].

### Pectin

Pectin can be used as a water binding stabiliser in this system and is used preferably at a level of 0.1-0.4%. It is a hydrocolloid, which helps to stabilise the air cells in the system when the product is heated and consumed.

### Sodium Citrate/Chelating Agent(s)

When coffee is present there is a tendency for precipitation. This precipitation can be reduced by the presence of a chelating agent. Preferably the chelating agent (e.g. up to a level of 0.5% ^{w}/_{w}) is a citrate such as sodium citrate. Most preferably the level of sodium citrate is about 0.1% ^{w}/_{w}.

### Other Flavours

Any other flavour and additive may be added as required in keeping with the nature of the product.

### Preparation Method

This product is designed to be brought and stored frozen, and prepared just prior to consumption. The idea behind the preparation is that the stable system of ice crystals is turned into a hot liquid system by melting the ice crystals and heating them. This is to be done by the use of a microwave. The microwave's radio waves are absorbed by the water, fat and carbohydrate in the product, and as they are absorbed the energy is converted to heat, thus heating the frozen hot drink mix and changing it into the liquid state. These radio waves are not, however, to be absorbed by the container (e.g. of cardboard and/or plastic packaging material) resulting in a hot drink in a cup which is able to be held straight after heating by the consumer.

### Packaging

Any form of packaging can be used for the composition where it is to be supplied in bulk. In the case of bulk packing of the composition for subsequent individualisation of serving, preferably it is packed in a form from whence it can be separated or can be taken to a thaw condition prior to individualised dispensing. Such individualised dispensing can be into a final drinking vessel or into a vessel in which it is heated (e.g. to a temperature above 50° C. and preferably below 95° C. sufficient to have it imbibed at a temperature in the range of from 50 to 95° C. and from thence placed in a drinking vessel.

Where however the composition is provided in a container to be used for a particular customer or retail or home user, preferably the container is one which, preferably with little or no risk nor soiling potential, is capable of being microwave heated to a preferred temperature of from 50 to 95° C.

Many forms of material are available for individual drinking vessels in which the composition can be supplied and in which it can be heated. Microwaveable plastics and other materials are of that kind but preferably for a product such as this ideally, a paperboard cup is utilised. Preferably also, for safety if desired, a click fit sipper cap can be provided. Such as sippercap (typified by those frequently used on aircraft for safety purposes) can overlie a seal of the content of the container. See for example U.S. Pat. Nos. 3,868,043, 4,428,498 and 6,070,755. Preferably a seal to close or substantially close the container is provided. Such a seal as a film or foil is preferably capable of being removed or pierced. The seal is preferably provided with a venting aperture.

A feature of the heating of a composition of the present invention to a temperature of from 50 to 95° C. is the prospect of continued exposure of the less dense foam as well as the more dense gas entraining solid and ensuing liquid to continued microwave heating. This does have a tendency of venting off of content to the atmosphere as a result of the foam being taken to higher temperatures than the liquid body and/or receiving microwave energy in excess of that demanded by its density.

The shielding of microwaves to selectively heat in a microwave oven is a characteristic that is well known in the art. Such shielding is generally provided by provision of a conductive material such as foil or metallised plastics film.

Our New Zealand Patent Application No. 539964 of 11 May 2005 disclosed a foil seal of the open topped container cup of paperboard thereby inherently providing for some measure of microwave shielding.

Examples of such shielding known in the art include U.S. Pat. No. 6,903,320 of Mars, Inc (published previously as US2004/0108313 1 Jun. 2004) which discloses a container for microwave thawing or heating of part of its content only reliant on shielding provided by selected parts of the container or foil associated therewith. It also discusses some earlier prior art including U.S. Pat. No. 4,233,325 where a syrup is to be heated but ice-cream is to be left unthawed and U.S. Pat. No. 5,718,370 which discloses a partially shielded microwave heating container having a layer of microwave shielding material laminated to a portion of a sheet of microwave permeable paperboard material that forms the container.

The packaging the hot drink mix preferably will be contained in is a paperboard cup with a microwave proof coating (low density Polyethylene) on the inside of the cup, to prevent moisture migration from the hot drink mix to the packaging. There is also a microwave proof coating (low density Polyethylene) on the outside of the cup to prevent moisture migration from the ice crystals that form on the cup during frozen storage. The lid may have two portions, a perforated plastic seal for tamper evidence, and on top of that a thermoformed plastic perforated coffee lid, which can also be microwaved.

FIG. 1 shows, by way of example, bleached kraft paperboard 4 having LDPE (5 and 6) extrusion coated (e.g. 15 gsm) on each side thereof and with scuff resistant low odour inks on its exterior 7.

Preferably the container is a cup form closed by a removable lid. Other forms however can be utilised including self supporting pouches or foil or otherwise sealed open topped containers.

FIG. 4 shows in an exploded view a paperboard cup to the rim of which a vent holed film or foil (substantial) seal sheet 9 can be adhered to be overlayed by a plastic (e.g. PE) sipper cup 10 with a spouted opening 11. The sheet 9 can be peel removed or pierced following heating to allow the beverage to be consumed.

The provision of a foil whether it is simply at the top of the cup form (e.g. affixed by an appropriate adhesive e.g. a lacquer or the like) or whether or not it is crimped or otherwise associated over and about the top of the cup form, will inherently have some shielding capability of the upper region of the cup and of course it is in this region that the foam is generated preferably any such foil if sealed is provided with a vent. The shielding can be extended if considered desirable and can be provided in part by other than the container seal or tear off.

In other forms of the present invention however any easily ruptureable or frangible weakness that serves the purpose can be utilised.

Alternatively an applied assembly or material can be provided over a perforate zone to achieve a like purpose.

Alternatively any other packaging suitable for microwave heating can be used.

Where the composition is in a and is capable as preferred of being microwaved in that container to heat the composition to a hot foamy beverage form, heating can be conducted with a removable lid removed that allows the beverage, after microwave heating to be drunk from the open cup. In practise however opening of such a pack for the purpose of microwave heating of the (or indeed any) frozen confection with incorporated air including composition in the open container may lead to soiling of both the microwave appliance and the exterior of the open container.

We recognise an advantage to be derived from a beverage pack capable, without opening (and preferably without removal of any seals or outer cover), of being microwave heated in order to bring a chilled or frozen confection with incorporated air including composition to a hot foamy beverage form. Such a form envisages the utilisation of a venting feature of the “closed” container of the pack above the level of the composition when (notionally or actually) liquid in the container as it would be positioned for microwave heating to allow venting of the entrained gas and any other gases generated from the container during heating.

Alternatively a tortuous path outlet can be provided which serves the purpose of the venting feature without allowing any direct ingress of contamination. This is a prospect particularly where the composition is to be maintained in a frozen state up until immediately prior to microwaving to the hot foamy beverage form.

### EXAMPLES

### Example 1

Caramel

| | Per | 100 g | |
|---|---|---|---|
| Energy | | 608.2 | kJ |
| | | 145.5 | kcal |
| Protein | | 3.6 | g |
| Fat | Total | 5.7 | g |
| | Saturated | 3.2 | g |
| Carbohydrates | Total | 19.8 | g |
| | Sugars | 19.6 | g |

### Example 2

Mochachino

| | Per | 100 g | |
|---|---|---|---|
| Energy | | 578.47 | kJ |
| | | 138.39 | kcal |
| Protein | | 3.67 | g |
| Fat | Total | 5.73 | g |
| | Saturated | 3.28 | g |
| Carbohydrates | Total | 17.75 | g |
| | Sugars | 17.31 | g |

### Example 3

Latte

| | Per | 100 g | |
|---|---|---|---|
| Energy | | 586.9 | kJ |
| | | 140.4 | kcal |
| Protein | | 3.7 | g |
| Fat | Total | 5.7 | g |
| | Saturated | 3.2 | g |
| Carbohydrates | Total | 18.4 | g |
| | Sugars | 18.1 | g |

### Example 4

Hot Choc

| | Per | 100 g | |
|---|---|---|---|
| Energy | | 649 | kJ |
| | | 155 | kcal |
| Protein | | 3.9 | g |
| Fat | Total | 6.5 | g |
| | Saturated | 3.7 | g |
| Carbohydrates | Total | 19.9 | g |
| | Sugars | 19.1 | g |

### Example 5

Process flow suitable for producing formulations of Examples 1 to 4.
Raw Materials from stores. Coffee extract from freezer. Tempered 2-3 days prior to mix making.
Mix to be made as per specification in mix dept. Pumping system needs to transfer coffee extract to mix vats.
Mix is homogenised 2000 psi first stage 500 psi 2^{nd} stage then pasturised at 84° C.
Mix pumped to MTF storage silos post pasturisation
Mix is aged. Also inspected and tested against standards.
Mix pumped to flavour hoppers in factory.
Mix flavoured and churned to set over run.
Product is filled into Paperboard cups to prescribed tolerance.
Apply unique foil seal and ensure proper crimping is achieved.
Transport upright through spiral freezer.
Check weigh individual units.
Product packed into outers, outers conveyed to distribution/freezers.

### Comments on Examples 1 to 4

Each of Examples 1 to 4 has a water content of about 60% ^{w}/_{w}, milk solids of about 15% ^{w}/_{w} (preferably more nonfat milk solids than cream), a sweetener (e.g. glucose), flavour(s), sodium citrate, glycerine, pectin and sodium caseinate. The hot chocolate may include chocolate chips.

The “on the go” hot beverages are rich and sweetly smooth with a velvety froth all the way through. The examples make beverages in four classic flavours coffee, caramel coffee, mocha and hot chocolate. The coffee flavours are crafted from 100% Arabica Espresso, the hot chocolate from authentic Brazilian cocoa beans and all use real milk. An 1100 w microwave releases the smooth and velvety texture in a paperboard (preferably partly shielded) cup in two and half minutes.

1.-21. (canceled)

22. A microwaveable frozen flavoured beverage composition that is
A) suitable for and intended for microwave heating from a frozen state directly to a foamy hot beverage form, or, is
B) suitable for and intended when thawed or partially thawed, and without mixing, for microwave heating directed to a foamy hot beverage form,
the frozen composition being of an air or other gas overrun substantially homogeneous mix of at least
colloidal protein or colloidal proteins,
a fat or fats,
water and/or a source of water,
at least one carbohydrate,
a beverage flavouring or beverage flavourings;
wherein a majority only of the water and/or source of water present in the frozen composition is in a frozen form;
and wherein at least one of (i) the colloidal protein or colloidal proteins, (ii) the fat and/or (iii) the water and/or source of water is or includes a dairy derived product;
and wherein at least one carbohydrate (iv) is in excess of each of (a) the colloidal protein or colloidal proteins (i) and (b) the fat or fats (ii) on a ^{w}/_{w} basis;
and wherein, on a ^{w}/_{w} % basis, the water and/or source of water (iii) [which may or may not be part of or all of the flavouring(s) (v)], irrespective of its physical state, is present as a, or the, major content of the composition on a ^{w}/_{w} basis.

23. A product of claim 22 which includes ice crystals.

24. A product of claim 22 wherein the composition has spread there throughout at least one or more of:
ice crystals of from 5 to 120 μm,
fat globules of from 0.2 to 40 μm, and
air cells of from 5 to 185 μm.

25. A product of claim 22 wherein the composition prior to freezing is an air or other gas overrun mix of at least
a milk concentrate,
a milk protein extract or powder,
cream, and at least one carbohydrate.

26. A product of claim 22 wherein a stabiliser is present

27. A product of claim 26 wherein there is at least 0.01% ^{w}/_{w} stabilising agent(s).

28. A product of claim 22 wherein the overrun is of from 10% to 120%.

29. A product of claim 22 wherein the composition prior to freezing has been a substantially homogenous mix of a gas overrun composition of at least:
up to 30% ^{w}/_{w} colloidal protein(s),
up to 20% ^{w}/_{w} fat(s),
up to 40% ^{w}/_{w} carbohydrate(s),
up to 5% ^{w}/_{w} stabilising agent(s),
up to 10% ^{w}/_{w} flavouring(s), and
up to 90% ^{w}/_{w} water.

30. A product of claim 29 wherein there is at least 0.5% ^{w}/_{w} colloidal protein(s).

31. A product of claim 29 wherein there is at least 5% ^{w}/_{w} carbohydrate(s).

32. A product of claim 22 wherein said fat or fats are from a dairy source.

33. A product of claim 22 wherein the colloidal protein or proteins are from a dairy source.

34. A microwavable product having at least in part dairy composition with a gas inclusion capable from a frozen state whilst still in all or part of its container in which it has been frozen or has been held frozen, of being safely microwave heated to a foamy hot beverage, and
wherein said composition prior to freezing has been a substantially homogenous mix of a gas overrun composition of at least:
up to 30% ^{w}/_{w} colloidal protein(s),
up to 20% ^{w}/_{w} fat(s),
up to 40% ^{w}/_{w} carbohydrate(s),
up to 5% ^{w}/_{w} stabilising agent(s),
up to 10% ^{w}/_{w} flavouring(s), and
up to 90% ^{w}/_{w} water.

35. A beverage pack comprising or including
at least substantially closed self supporting container, and
a chilled or frozen composition with incorporated air or other gas in the container, wherein a majority only of the water and/or source of water present in the frozen composition is in a frozen form;
wherein the pack can be microwaved to heat the composition to a foamy beverage form,
and wherein the pack can be opened or penetrated to allow the drinking of the foamy beverage,
and wherein the at least substantially closed self supporting container includes a venting feature above the level of the composition in the container.

36. A pack of claim 35 wherein the at least substantially closed self supporting container is a cup having a removable lid.

37. A pack of claim 35 that includes instructions to microwave heat the pack in a modified or unmodified form, which heating, if carried out, results in a foamy beverage in the temperature range of from 50 to 90° C. capable of being drunk from the container in a modified or unmodified form.
